(19) United States
(12) Patent Application Publication
(10) Pub. No.: US 2021/0131276 A1
(43) Pub. Date: May 6, 2021

(54) System and Method to Obtain Vertical Seismic Profiles in Boreholes Using Distributed Acoustic Sensing on Optical Fiber Deployed Using Coiled Tubing

(71) Applicant: Halliburton Energy Services, Inc., Houston, TX (US)

(72) Inventors: Michel Joseph LeBlanc, Houston, TX (US); Mark Elliott Willis, Katy, TX (US); Andreas Ellmauthaler, Houston, TX (US); Dan Quinn, Spring, TX (US); Philippe Quero, Houston, TX (US); Mikko Jaaskelainen, Houston, TX (US); Alexis Garcia, The Woodlands, TX (US)

(73) Assignee: Halliburton Energy Services, Inc., Houston, TX (US)

(21) Appl. No.: 16/345,774

(22) PCT Filed: Oct. 10, 2018
(86) PCT No.: PCT/US2018/055215

§ 371 Date: Apr. 29, 2019

Related U.S. Application Data
(60) Provisional application No. 62/584,554, filed on Nov. 10, 2017.

(51) Int. Cl. E21B 47/135; E21B 47/07; E21B 19/22; G01V 1/52

(52) U.S. Cl. CPC E21B 47/135; E21B 47/07; G01V 2210/161; G01V 1/52; G01V 2210/1429; E21B 19/22

(57) ABSTRACT

A system and a method for performing a borehole operation, wherein the system may comprise a coiled tubing string and a fiber optic cable disposed in the coiled tubing string and wherein the fiber optic cable is strain-coupled to the coiled tubing string. A method of performing a borehole operation may comprise disposing a coiled tubing string into a borehole and wherein a fiber optic cable is strain-coupled to the coiled tubing string, and measuring at least one property of the borehole with the fiber optic cable.

### BACKGROUND

Boreholes drilled into subterranean formations may enable recovery of desirable fluids (e.g., hydrocarbons) using a number of different techniques. Knowing the type of formation during drilling operations may be beneficial to operators as a bottom hole assembly traverses through different formations. For example, currently after the conclusion of drilling operations, a wireline system may be placed within the borehole and measurements may be taken, covering a specific depth range. A vibration source, disposed on the surface, may be activated to cast acoustic waves into formations below. A wireline system may detect, record, and measure acoustic waves as they traverse and/or are reflected through the formation. Processing of recorded acoustic waves may be used to produce a profile of acoustic velocity for the rock formations traversed by the acoustic waves. An acoustic velocity profile may be used for identification of rock formations or to measure various rock properties. Measuring the velocity of acoustic waves may be repeated many times to form a vertical seismic profile.

Reviewing a vertical seismic profile may indicate to an operator that a wellbore operation may be beneficial to the borehole for production. It is time consuming and expensive to remove the wireline system, rig up the coil tubing, and dispose coil tubing in the borehole for further borehole operations. Additionally, it may be time consuming and expensive to rig down the coil tubing so a wireline system may be rigged up to determine the effects of the work on the borehole. If the effects on the borehole are not satisfactory, even more time, money, and effort will be exerted to rig down the wireline and repeat the process. Examples of common types of operations in which this may occur are stimulation of the borehole, cleanup, fracking, and/or acidizing and nitrogen lift. A system and method that may perform stimulation operations and be able to record measurements to produce a vertical seismic profile at the same time may be beneficial.

### BRIEF DESCRIPTION OF THE DRAWINGS

These drawings illustrate certain aspects of some examples of the present disclosure, and should not be used to limit or define the disclosure.

FIG. 1 illustrates an example of a coiled tubing string; and

FIG. 2 illustrates an example of a treatment operation in a borehole.

### DETAILED DESCRIPTION

This disclosure may generally relate to a system and method for collecting seismic data. More particularly, embodiments may relate to collecting seismic data while the coiled tubing, instrumented with an optical fiber, is in the borehole. A fiber-instrumented coiled tubing may allow for multiple applications to be performed while coiled tubing is disposed in the borehole, such as producing seismic products in boreholes using distributed acoustic sensing.

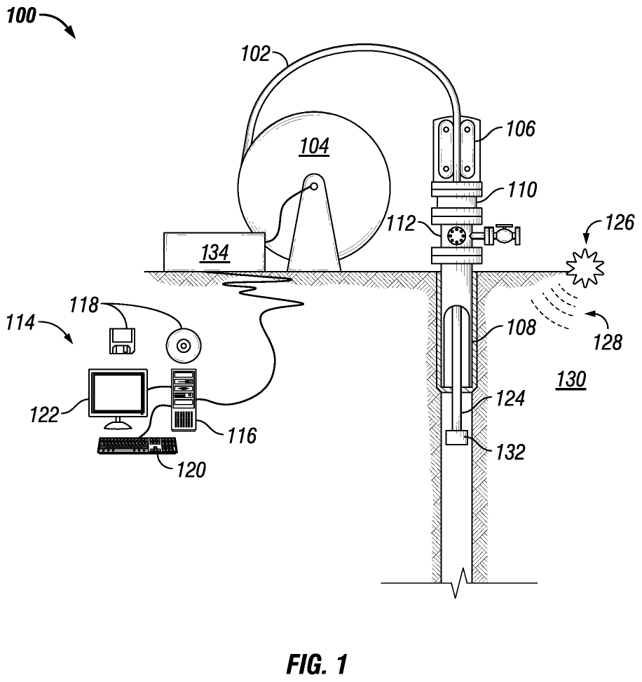

FIG. 1 illustrated coiled tubing system 100, which may include a coiled tubing string 102. In examples, coiled tubing string 102 may be coupled with a bottom hole assembly (not illustrated) made up of various subs and tools, such as a gamma ray sensing tool, a casing locator tool, or a pulse telemetry tool. Coiled tubing string 102 may be disposed around and/or removed from spool 104 by a tubing injector 106 and injected into a borehole 108 through a packer 110 and a blowout preventer 112. This may allow coiled tubing string 102 to traverse along borehole 108. As shown, borehole 108 may be vertical. However, as detailed further below, borehole 108 may be of fairly extensive reach eventually turning horizontal. Additionally, directional drilling may result in a tortuous borehole 108 with many bends and turns. Coiled tubing operations may be suited to provide access to such borehole 108, considering that deploying wireline tools in such borehole 108 may require a powered tractor tool, adding cost and weight to the instrumentation string and adding time to the operation.

In examples, coiled tubing string 102 may be a continuous length of steel, alloy steel, stainless steel, composite tubing, or other suitable metal or non-metal material that may be flexible enough to be wound on spool 104 for transportation, and spool 104 itself may be located on a coiled tubing truck for mobility (not illustrated). Due to the relative lack of joints, it may be advantageous to use coiled tubing string 102 when pumping chemicals downhole.

In borehole 108, coiled tubing string 102 may include a sub and one or more tools coupled to coiled tubing string 102, which may make up the bottom hole assembly. The sub may control communication between uphole and downhole elements, and may also control communication between downhole elements such as the one or more tools by providing a common clock, power source, communication bus, and the like. The tools may be subs, or other sections of coiled tubing string 102, that perform functions particular to a coiled tubing operation. For example, in a perforation operation the tools may include a perforation tool including perforating guns and the like. As another example, in a milling operations the tools may include a milling tool including a bit. Without limitation, coiled tubing applications may be performed offshore as well.

Tools disposed at the end of coiled tubing string 102 may be controlled by information handling system 114. Additionally, measurements taken and/or performed by the tools may be transmitted to information handling system 114. As illustrated, the information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a personal computer, a network storage device, or any other suitable device and may vary in size, shape, performance, functionality, and price. Information handling system 114 may include a processing unit 116 (e.g., microprocessor, central processing unit, etc.) that may process EM log data by executing software or instructions obtained from a local non-transitory computer readable media 118 (e.g., optical disks, magnetic disks) Non-transitory computer readable media 118 may store software or instructions of the methods described herein. Non-transitory computer readable media 148 may include any instrumentality or aggregation of instrumentalities that may retain data and/or instructions for a period of time. Non-transitory computer readable media 118 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 114 may also include input device(s) 120 (e.g., keyboard, mouse, touchpad, etc.) and output clevice(s) 152 (e.g., monitor, printer, etc.). The input device(s) 120 and output device(s) 122 provide a user interface that enables an operator to interact with tools coupled to coiled tubing string 102. For example, information handling system 114 may enable an operator to select analysis options, view collected log data, view analysis results, and/or perform other tasks.

In examples, a fiber optic cable 124 may be disposed within coiled tubing string 102. Fiber optic cable 124 may be utilized as a communication medium between information handling system 114 and a tool disposed on coiled tubing string 102, or may be used for sensing, such as via distributed temperature sensing (“DTS”). Fiber optic cable 124 may consist of one or multiple optical fibers, which may all be single-mode fiber, all multimode fibers, and/or a combination of multimode fibers and single mode fibers. In addition, the fiber optic cable may be integrated within an electrically conductive cable wherein both optical fibers and electrical cables may be bundled together. In examples, the electrical cables may include electrical wire. The electrical wires may be used for powering downhole tools, transmitting data to and from the surface, sending commands to and from the surface, and/or be used for telemetry purposes, and/or a combination thereof. In examples fiber optic cable 124 may be utilized as a tool for distributed acoustic sensing (“DAS”), which may be utilized to produce a vertical seismic profile (“VSP”). To produce a VSP, acoustic waves traveling in a rock formation, which may be elastic waves, produce dynamic strains in the rock formations, which may be recorded. These strains may be conveyed to fiber optic cable 124 disposed in coiled tubing string 102.

In examples, fiber optic cable 124 may be strain-coupled to coiled tubing string 102, which may allow for the transfer of forces to fiber optic cable 124. Therefore, the strain experienced by coiled tubing string 102 may be transferred to fiber optic cable 124, which may allow for strain to be measured. For example, motion of the surrounding rocks in formation 130 may affect coiled tubing string 102, and in turn, the motion of coiled tubing string 102 may produce strain in fiber optic cable 124. Unless care is taken to ensure the uniformity of the strain-coupling mechanism holding fiber optic cable 124 to coiled tubing string 102, the sensitivity of fiber optic cable 124 to the motion may vary along borehole 108. For example, at a location along coiled tubing string 102, fiber optic cable 124 may be suspended within coiled tubing string 102 and not in contact with the walls of coiled tubing string 102. Thus, strains exhibited on coiled tubing string 102 may be transferred only in part to fiber optic cable 124. In examples, strain measurements may be averaged over the length of fiber optic cable 124 bounded by the nearest locations where contact exists between fiber optic cable 124 and a wall of coiled tubing string 102 to determine strain measurements. A similar problem may exist in the strain coupling between borehole 108 and coiled tubing string 102. To record a seismic signal with minimal noise, borehole 108 may be in contact with the coiled tubing string 102 over at least a part of the length of interest to produce a VSP profile. Additionally, contact between fiber optic cable 124 and the inner wall of coiled tubing string 102 may also improve the sensing, recording, and measuring of seismic waves over at least a part of the same length.

To achieve a suitable strain coupling, fiber optic cable 124 may include “extra cable length” to ensure that fiber optic cable 124 may be in physical communication within coiled tubing string 102 as a result of the buckling caused by the axial force necessary to keep the extra cable length in the coiled tubing string 102. In other words, fiber optic cable 124 disposed in coiled tubing string 102 may be longer than coiled tubing string 102 such that there is extra length of fiber optic cable 124 in coiled tubing string 102. In examples, fiber optic cable 124 may have a length longer than the coiled tubing string 102 by at least 1%, 5%, 10%, or more. In examples, strain coupling may also include welding fiber optic cable 124 to the inner diameter of coiled tubing string 102 during manufacturing of coiled tubing string 102. Additionally, fiber optic cable 124 may be magnetized and/or attach to coiled tubing string 102 through a mechanical device such as a bracket, or an expanding (grid-like) tube within coiled tubing string 102. It should be noted that fiber optic cable 124 may be disposed on the inner diameter and/or outer diameter of coiled tubing string 102. In examples, the inner diameter of coiled tubing string 102 may provide protection to fiber optic cable 124 during borehole operations.

During operations, coiled tubing string 102 may be disposed within borehole 108 and may be in communication with the inner diameter of borehole 108 and/or a cement casing of borehole 108. In examples, a seismic source 126 may be utilized to produce seismic waves 128 that may traverse through formation 130 and may be recorded by fiber optic cable 124. Seismic source 126 may include vibroseis, dynamite, thumper, and/or air-gun in pit/pool. In offshore applications, seismic source 126 may be an air-gun. Fiber optic cable 124 may be part of a distributed acoustic system (“DAS”), which may interrogate fiber optic cable 124 at a frequency suitable to obtain seismic data. Seismic data may be recorded by the DAS through fiber optic cable 124 and may be processed by information handling system 114 to produce a VSP and/or similar seismic products.

In examples a tool 132 may be coupled to coiled tubing string 102. It should be noted that tool 132 may be coupled about an end of coiled tubing string 102 and/or at any other suitable location along coiled tubing string 102. Tool 132 may include a collar locator, a gamma ray device, a vibroseis source, and/or the like. It should be noted that tool 132 may comprise an array of geophones disposed at the end of coiled tubing string 102. In examples, geophones may be disposed at any location along coiled tubing string 102. Geophones may operate as calibration points for the position of fiber optic cable 124 in relation to coiled tubing string 102. Additionally, geophones may operate to produce angle-of-incident correction data for the DAS, which may be integrated into the VSP.

Tool 132 may also include a clamping mechanism. The clamping mechanism may operate to clamp to borehole 108. The clamping mechanism may be a side-arm that is extendable any may be controlled from the surface. The actuation force to deploy the side-arm may be from an electrical actuator, from a hydraulic system, of based on a pre-loaded spring mechanism. The actuation may also come from fluid pumped within coiled tubing string 102, or may be actuated by adding tension or push to coiled tubing string 102. Once in place, the clamping mechanism may permit an operator to add tensions and/or compression to coiled tubing string 102 from the surface. During these operations, an operator or service provider may straighten coiled tubing string 102 through tension or form a helical contact against the inner diameter wall of borehole 108 through compression. In both cases, a strain coupling may be found between borehole 108 and coiled tubing string 102, which may produce reliable and accurate VSP data using DAS.

Without limitation, tool 132 may include a sonic tool, which may generate tube waves within borehole 108. An attached sonic tool may generate tube waves in the fluid filled borehole 108 that may propagate to the surface. These tube waves may be recorded at the surface by instruments attached to information handling system 114. The DAS, connected with fiber optic cable 124 may interrogate fiber optic cable 124 at a frequency suitable to obtain seismic data from the tube waves. The tube waves may act as an aid to depth calibrations of fiber optic cable 124 or illuminate elements (not illustrated) in borehole 108 (i.e. casing junctions, end points of casing strings, etc.). Tube waves may induce a dynamic strain signal in fiber optic cable 124, which may be recorded by the DAS system on information handling system 114.

For example, fiber optic cable 124 may operate as an acoustic receiver for receiving seismic waves 128 transmitted from seismic source 126. Seismic waves 128 may cause vibrations, including variations in strain, in fiber optic cable 124. An optical interrogator 134 connected to fiber optic cable 124 detects variations in light as transmitted through fiber optic cable 124 due to the vibrations, and thereby detects the presence (or lack of) seismic waves 128.

In a DAS system, optical interrogator 134 may launch pulses of light into the fiber optic cable 124 and detect backscattering of light (e.g., coherent Rayleigh backscattering) through fiber optic cable 124. In an interferometric or fiber Bragg grating systems, optical interrogator 134 may detect variations in reflected amplitude and or phase of reflected light (e.g., from fiber Bragg gratings, etc.) through fiber optic cable 124, in order to detect seismic waves 128. Alternatively, if fiber optic cable 124 is in the form of a loop that travels from the surface, into the well and back to the surface, i.e., if both ends of fiber optic cable 124 are accessible at the surface, changes in amplitude and or phase of transmitted light may also be used to interrogate the system.

In examples, tube waves may be used to provide a depth profile of the cable position along borehole 108. For example, a tube wave propagating in borehole 108 (also known as Stoneley waves) may be assumed to travel at a uniform speed along segments of borehole 108. The tracking of the position of the wave along fiber optic cable 124 may therefore be used to re-calibrate the measured position in the DAS signal and the computed position based on the uniform wave travel speed. Reflections of Stoneley waves at known points (such as casing diameter changes) may also be used to improve the depth calibration. In examples, one or more vibroseis sources may be positioned at the well-head to reduce the amplitude of surface waves, which may reduce generation of tube waves at the surface. Other characteristics of the tube waves may be of interest for the characterization of borehole 108 or a reservoir. For example, fractures in a reservoir may cause changes in amplitudes, and reflections in the tube waves. Additional resonances may also be observed in the tube waves as a result of the interaction of borehole fluid with the fluid in fractures in the rocks surrounding borehole 108.

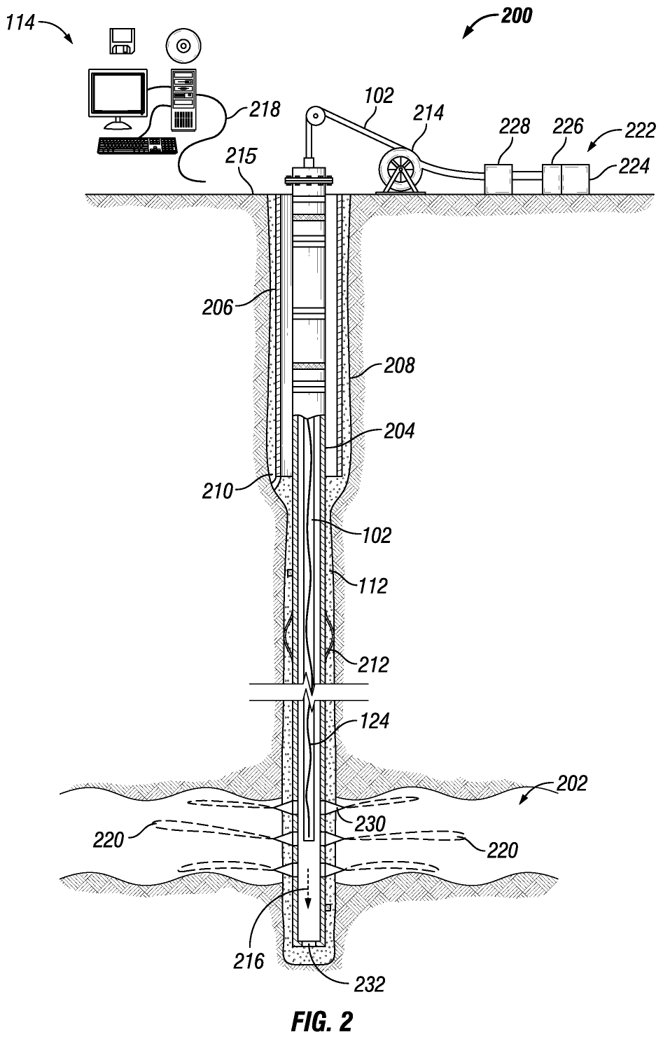

As illustrated in FIG. 2, coiled tubing string 102 may be utilized in treatment operations. Without limitation, treatment operations may be fracking operation, cleanup operations, acidizing and/or nitrogen lift operations, and/or any similar operation. FIG. 2 illustrates a fracking operation. During operations, two sets of coiled tubing string 102 may be employed. A first coiled tubing string may be disposed in a treatment well 200. A second coiled tubing string may be disposed in an observation well (not illustrated) to monitor the operations within treatment well 200. FIG. 2 illustrates an example treatment well 200 for use with a subterranean well. In the illustrated embodiment, treatment well 200 may be used to stimulate a formation 202 (e.g., fracking, acid matrix stimulation, etc.) through coil tubing string 102. In examples, coil tubing string 102 may be disposed within conduits (e.g., first casing 204, second casing 206, etc.). The conduits may comprise a suitable material, such as steel, chromium, or alloys. As illustrated, a borehole 208 may extend through formation 202 and/or a plurality of formations 130. While borehole 208 is shown extending generally vertically into formation 202, the principles described herein are also applicable to boreholes that extend at an angle through formation 202, such as horizontal and slanted boreholes. For example, although FIG. 2 shows a vertical or low inclination angle well, high inclination angle or horizontal placement of the well and equipment is also possible. It should further be noted that while FIG. 2 generally depicts a land-based operation, those skilled in the art will readily recognize that the principles described herein are equally applicable to subsea operations that employ floating or sea-based platforms and rigs, without departing from the scope of the disclosure.

As illustrated on FIG. 2, one or more conduits, shown here as first casing 204 and second casing 206 may be disposed in the borehole 208. First casing 204 may be in the form of an intermediate casing, a production casing, a liner, or other suitable conduit, as will be appreciated by those of ordinary skill in the art. Second casing 206 may be in the form of a surface casing, intermediate casing, or other suitable conduit, as will be appreciated by those of ordinary skill in the art. While not illustrated, additional conduits may also be installed in the borehole 208 as desired for a particular application. In the illustrated embodiment, first casing 204 and the second casing 206 may be cemented to the walls of borehole 208 by cement 210. Without limitation, one or more centralizers 212 may be attached to either first casing 204 and/or the second casing 206, for example, to centralize the respective conduit in borehole 208, as well as protect additional equipment (e.g., electromagnetic field sensors, not illustrated).

In the illustrated embodiment, treatment well 200 may comprise a hoist 214. In examples, coil tubing string 102 may be spooled within hoist 214. In examples, hoist 214 may be used to raise and/or lower coil tubing string 102 in borehole 208. Coil tubing string 102 may also deliver fluids, proppants, and/or the like downhole to formation 202. As discussed below, there may be additional tools that may be disposed on coil tubing string 102.

Treatment well 200 may further comprise an information handling system 114. As illustrated, information handling system 114 may be disposed at surface 215. In examples, information handling system 114 may be disposed downhole. Any suitable technique may be used for transmitting signals from coil tubing string 102 to information handling system 114. As illustrated, a communication link 218 (which may be wired or wireless, for example) may be provided that may transmit data from fiber optic cable 124 to information handling system 114. Information handling system 114 may be adapted to receive signals from fiber optic cable 124 that may be representative of measurements from a tool disposed on coil tubing string 102. Information handling system 114 may act as a data acquisition system and possibly a data processing system that analyzes measurements, for example, to derive one or more properties of formation 202, measurements and/or information from tool, and/or analyzing measurements on work performed by treatment well 200.

FIG. 2 further illustrates treatment well 200 in operation to introduce a fluid into fractures 220. Treatment well 200 may include a fluid handling system 222, which may include fluid supply 224, mixing equipment 226, and pumping equipment 228 which may be connected to coil tubing string 102. Pumping equipment 228 may be fluidly coupled with the fluid supply 224 and coil tubing string 102 to communicate a fracturing fluid 216 into borehole 208. Fluid supply 224 and pumping equipment 228 may be above surface 215 while borehole 208 is below surface 215.

Treatment well 200 may also be used for the injection of a pad or pre-pad fluid into formation 202 at an injection rate above the fracture gradient to create at least one fracture 220 in formation 202. Treatment well 200 may then inject fracturing fluid 216 into formation 202 surrounding borehole 208 through perforation 230. Perforations 230 may allow communication between borehole 208 and formation 202. As illustrated, perforations 230 may penetrate first casing 204 and cement 210 allowing communication between interior of first casing 204 and fractures 220. A plug 232, which may be any type of plug for oilfield applications (e.g., bridge plug), may be disposed in borehole 208 below perforations 230.

In accordance with systems, methods, and/or compositions of the present disclosure, fracturing fluid 216 may be pumped via pumping equipment 228 from fluid supply 224 down the interior of first casing 204 through coil tubing string 102 and into formation 202 at or above a fracture gradient of formation 202. Pumping fracturing fluid 216 at or above the fracture gradient of formation 202 may create (or enhance) at least one fracture (e.g., fractures 220) extending from the perforations 230 into formation 202. During fracking operations, fiber optic cable 124 may record information and measurements regarding the progression of the fracking operations. This information may be processed and displayed on a VSP at various stages prior to, during, and after a hydraulic fracturing operation. A VSP profile may have been obtained using coiled tubing string 102 in which fiber optic cable 124 may be disposed prior to the fracking operation to be used as a baseline. Recorded information and measurements may be communicated to information handling system 114 on surface 215 from fiber optic cable 124. Seismic data, using a downhole acoustic source, or one or more sources at surface 215, may also be collected simultaneous with the fracking operation. The fracking operation may be dividing into stages such that a first type of fluid is pumped, seismic data is obtained, and then a second type of fluid is pumped. For example, a first fluid may consist of pad fluid, not containing proppant, and be used to create fractures 220. While the fracture is held open, seismic data may be obtained. Following this, proppant may then be pumped, e.g. in a second fluid, to insert proppant in fractures created during the fracking operation. Further seismic data may then be collected both before the release of pressure and after. For example, data may be collected prior to pumping operations of fluid 216 and prior to creation of fracture 220. Data may be collected after the release of pressure and crack closure. Monitoring of fracking operations may be performed with coiled tubing string 102 disposed in treatment well 200, either with coiled tubing string 102 utilized for the delivery of fracturing fluid, or with coiled tubing string 102 simply monitoring the fracturing job and the fracturing fluid being pumped in the well itself, outside of coiled tubing 102.

In examples, keeping track of the positon of fiber optic cable 124 relative to coiled tubing string 102 (Referring to FIG. 1), more generally, relative to borehole 108, in-situ fiber measurements may be utilized to map the length of fiber optical cable 124. This may include a strain measurement, fiber curvature measurement, fiber temperature measurement, and/or energy of backscattered light measurement. A strain measurement may be performed by an operation of Brillouin scattering (via Brillouin Optical Time-Domain Reflectometry, BOTDR, or Brillouin Optical Time-Domain Analysis, BOTDA), or Rayleigh scattering utilizing Optical Frequency Domain Reflectometry (OFDR). A Fiber curvature measurement may be performed using Polarization Optical Time Domain Reflectometry (P-OTDR) or Polarization-Optical Frequency Domain Reflectometry (P-OFDR). A Fiber temperature measurement may be performed utilizing Raman DTS. An energy of backscattered light of DAS measurement may be performed utilizing an automatic thresholding scheme, the fiber end is set to the DAS channel for which the backscattered light energy flat lines. The purpose of these measurements may be to compute the length of fiber optical cable 124, and its distributed curvature. The distributed curvature provides a measurement of the bending of fiber optical cable 124 and therefore may determine the pitch of the spiral or sinusoidal pattern the cable makes within coiled tubing string 102 and the pitch of the spiral or sinusoidal pattern that coiled tubing string 102 makes within borehole 208. These measurements may assist in identifying a position along fiber optic cable 124, where measurements were recorded by the DAS system during the VSP data acquisition. In examples, these measurements may be used in conjunction with acoustic methods using Stoneley (tube) waves described above.

DAS measurements provide a single-component of strain, in the axial direction of fiber optic cable 124, and, depending on the type of waves generated in borehole 208, it may be of interest to be able to measure other components of the strain. This may be achieved with a coiled tubing string 102 in which geophones or accelerometers may be attached. Geophones and accelerometers may be able to sense, measure, and/or record motion traversing across coiled tubing string 102. In examples, geophones and accelerometers comprise optical or electrical sensors. The output of the electrical geophones may be converted to acoustic signal using piezo-electric or magnetostrictive elements which may produce a strain signal within fiber optic cable 124 in accordance with the measured signal from a geophone. Such conversion from geophone or accelerometer output may be performed in an analog signal domain (e.g., a tone frequency may be produced which may vary with signal strength) or the electrical signals from the transducers may first be digitized with local electronics and conveyed digitally (or by processed analog signals) to the optical fiber using an electro-acoustic transducer placed in proximity to fiber optic cable 124. Other sensors, such as EM, hydrophone, or temperature sensors may also be placed along coiled tubing string 102 and their signal converted to produce an acoustic response.

The conversion may include the production of a frequency tone, the value of which may be related to the quantity measured. The same frequency signal may also be used as a known location point to further assist with the calibration of position of fiber optic cable 124 along coiled tubing string 102 and, more generally, within borehole 208. Geophones, accelerometers, or hydrophones output may be used to assist in the interpretation of the VSP signals. For example, they may be used to better differentiate between P and S waves in the data collected by the DAS. The sensors deployed along coiled tubing string 102 and utilizing fiber optic cable 124 as telemetry channel (acoustic telemetry) may be contained within coiled tubing string 102 or clamped externally to coiled tubing string 102. The sensors may also be present in borehole 208 (e.g., behind casing) and use fiber optic cable 124 as the acoustic telemetry channel while coiled tubing string 102 may be disposed in borehole 208.

In examples, it may be desirable to deploy a coiled tubing string 102 in a borehole 208 for an extended period of time, to be used for measurements over the extended period of time. Additionally, a “sensing string” may also be deployed in an observation well, and may even be cemented in place to reside permanently in borehole 208.

The preceding description provides various examples of the systems and methods of use disclosed herein which may contain different method steps and alternative combinations of components.

Statement 1. A system may comprise a coiled tubing string and a fiber optic cable disposed in the coiled tubing string and wherein the fiber optic cable is strain-coupled to the coiled tubing string.

Statement 2. The system of statement 1, wherein strain-coupling between the coiled tubing string and the fiber optic cable is formed through a weld, a bracket, magnetization, or an expanding tube.

Statement 3. The system of statements 1 or 2, wherein the fiber optic cable is welded to an inner diameter of the coiled tubing string.

Statement 4. The system of statements 1 to 3, wherein the fiber optic cable is longer than the coiled tubing string in which the fiber optic cable is disposed such that extra length of the fiber optic cable is disposed in the coiled tubing string.

Statement 5. The system of statements 1 to 4, further comprising a vibroseis source, wherein the vibroseis source is configured to reduce an amplitude of a surface wave at a well-head.

Statement 6. The system of statements 1 to 5, further comprising a tool, wherein the tool is coupled to the coiled tubing string and the tool is at least one geophone, a collar locator, a gamma ray device, or a vibroseis source.

Statement 7. The system of statements 1 to 6, further comprising a clamping mechanism coupled to the coiled tubing string and wherein the clamping mechanism attaches the coiled tubing string to a wall of a borehole.

Statement 8. The system of statements 1 to 7, further comprising a sonic tool coupled to the coiled tubing string and wherein the sonic tool generates a tube wave.

Statement 9. The system of statements 1 to 8, further comprising a distributed acoustic sensing system. The distributed acoustic sensing system may comprise an optical interrogator, wherein the optical interrogator is connected to the fiber optic cable. The optical interrogator may be configured to transmit a light into the fiber optic cable and detect variation in the light as the light traverses the fiber optic cable. The distributed acoustic system may further comprise an information handling system, wherein the information handling system may be capable of processing the variation in the light to determine a property of the borehole.

Statement 10. The system of statements 1 to 9, wherein the coiled tubing string is strain-coupled to a borehole and the strain-coupling is formed through a weld, a bracket, magnetization, or an expanding tube.

Statement 11. The system of statements 1 to 10, wherein the fiber optic cable is disposed in a bundle with an electrical cable, where in the electrical cable is one or more electrical wires.

Statement 12. The system of statements 1 to 11, wherein the fiber optic cable is a plurality of optical fibers.

Statement 13. A method of performing a borehole operation may comprise disposing a coiled tubing string into a borehole and wherein a fiber optic cable is strain-coupled to the coiled tubing string and measuring at least one property of the borehole with the fiber optic cable.

Statement 14. The method of statement 13, further comprising processing the at least one property of the borehole with an information handling system, creating a vertical seismic profile from the at least one property of the borehole; and displaying a vertical seismic profile for an operator.

Statement 15. The method of statements 13 or 14, wherein the fiber optic cable is welded to an inner diameter of the coiled tubing string.

Statement 16. The method of statements 13 to 15, wherein the fiber optic cable is longer than the coiled tubing string in which the fiber optic cable is disposed such that extra length of the fiber optic cable is disposed in the coiled tubing string.

Statement 17. The method of statements 13 to 16, further comprising a vibroseis source, wherein the vibroseis source is configured to reduce an amplitude of a surface wave at a well-head.

Statement 18. The method of statements 13 to 17, further comprising disposing a second coiled tubing string in a second borehole and coupling at least one sensor on the second coiled tubing string.

Statement 19. The method of statements 13 to 18, wherein the fiber optic cable is disposed in a bundle with an electrical cable, where in the electrical cable is one or more electrical wires.

Statement 20. The method of statements 13 to 19, wherein the fiber optic cable is a plurality of optical fibers.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A system comprising:
a coiled tubing string; and
a fiber optic cable disposed in the coiled tubing string and wherein the fiber optic cable is strain-coupled to the coiled tubing string.

2. The system of claim 1, wherein strain-coupling between the coiled tubing string and the fiber optic cable is formed through a weld, a bracket, magnetization, or an expanding tube.

3. The system of claim 1, wherein the fiber optic cable is welded to an inner diameter of the coiled tubing string.

4. The system of claim 1, wherein the fiber optic cable is longer than the coiled tubing string in which the fiber optic cable is disposed such that extra length of the fiber optic cable is disposed in the coiled tubing string.

5. The system of claim 1, further comprising a vibroseis source, wherein the vibroseis source is configured to reduce an amplitude of a surface wave at a well-head.

6. The system of claim 1, further comprising a tool, wherein the tool is coupled to the coiled tubing string and the tool is at least one geophone, a collar locator, a gamma ray device, or a vibroseis source.

7. The system of claim 1, further comprising a clamping mechanism coupled to the coiled tubing string and wherein the clamping mechanism attaches the coiled tubing string to a wall of a borehole.

8. The system of claim 1, further comprising a sonic tool coupled to the coiled tubing string and wherein the sonic tool generates a tube wave.

9. The system of claim 1, further comprising a distributed acoustic sensing system, wherein the distributed acoustic sensing system comprises:
an optical interrogator, wherein the optical interrogator is connected to the fiber optic cable and the optical interrogator is configured to:
transmit a light into the fiber optic cable; and
detect variation in the light as the light traverses the fiber optic cable; and
an information handling system, wherein the information handling system is capable of processing the variation in the light to determine a property of the borehole.

10. The system of claim 1, wherein the coiled tubing string is strain-coupled to a borehole and the strain-coupling is formed through a weld, a bracket, magnetization, or an expanding tube.

11. The system of claim 1, wherein the fiber optic cable is disposed in a bundle with an electrical cable, and wherein the electrical cable is one or more electrical wires.

12. The system of claim 1, wherein the fiber optic cable is a plurality of optical fibers.

13. A method of performing a borehole operation comprising:
disposing a coiled tubing string into a borehole and wherein a fiber optic cable is strain-coupled to the coiled tubing string; and
measuring at least one property of the borehole with the fiber optic cable.

14. The method of claim 13, further comprising processing the at least one property of the borehole with an information handling system, creating a vertical seismic profile from the at least one property of the borehole; and displaying a vertical seismic profile for an operator.

15. The method of claim 13, wherein the fiber optic cable is welded to an inner diameter of the coiled tubing string.

16. The method of claim 13, wherein the fiber optic cable is longer than the coiled tubing string in which the fiber optic cable is disposed such that extra length of the fiber optic cable is disposed in the coiled tubing string.

17. The method of claim 13, further comprising a vibroseis source, wherein the vibroseis source is configured to reduce an amplitude of a surface wave at a well-head.

18. The method of claim 13, further comprising disposing a second coiled tubing string in a second borehole and coupling at least one sensor on the second coiled tubing string.

19. The method of claim 13, wherein the fiber optic cable is disposed in a bundle with an electrical cable, and wherein the electrical cable is one or more electrical wires.

20. The method of claim 13, wherein the fiber optic cable is a plurality of optical fibers.
